(19) United States
(12) Patent Application Publication
(10) Pub. No.: US 2026/0336601 A1
(43) Pub. Date: Oct. 29, 2026

(54) METHOD AND SYSTEM FOR ASSISTING A VEHICLE IN MAKING A TURN

(71) Applicant: AUMOVIO Autonomous Mobility Germany GmbH, Ingoistadt (DE)

(72) Inventors: Rakshitha Gopal, Bangalore (IN); Srividhya Kannan, Chennai (IN); Radhika Ramachandran, Bangalore (IN)

(21) Appl. No.: 19/652,043

(22) Filed: Apr. 20, 2026

(30) Foreign Application Priority Data
Apr. 23, 2025 (GB) 2506012.0

(51) Int. Cl. B60W 30/045; B60W 30/09; B60W 30/095; B60W 50/14

(52) U.S. Cl. CPC B60W 30/045; B60W 30/09; B60W 30/0956; B60W 50/14; B60W 2300/145; B60W 2420/403; B60W 2420/408; B60W 2530/201; B60W 2554/402; B60W 2554/4041; B60W 2556/40

(57) ABSTRACT

A system comprises a processing circuitry configured to receive a destination route map comprising routes for the vehicle. The processing circuitry is configured to receive data associated with surroundings of the vehicle and determine a turn clearance status based on the data, one or more dimensions of the vehicle, and at least one selected route of the one or more routes. The turn clearance status comprises at least one of: a positive status or a negative status. The processing circuitry is further configured to determine a first turn trajectory for a first unit of the vehicle and a second turn trajectory for a second unit of the vehicle. The processing circuitry is configured to initiate a turn for the first unit and the second unit in the first turn trajectory and the second turn trajectory when the turn clearance status comprises the positive status.

### CROSS-REFERENCE TO RELATED APPLICATIONS

This application claims priority to Great Britain Patent Application No. 2506012.0, filed Apr. 23, 2025, which is incorporated herein by reference in its entirety.

### TECHNICAL FIELD

The present disclosure in general relates to vehicle turning operations. More particularly, the present disclosure relates to a method and a system for assisting a vehicle in making a turn.

### BACKGROUND

Long vehicles, like buses, trailers, articulated vehicles, and heavy trucks, face significant challenges while navigating turns due to their extended length and large turning radii. These long vehicles often require a swinging out manoeuvre to successfully complete turns without colliding with curbs, vehicles, or obstacles. However, this manoeuvre introduces several safety risks, including potential lane encroachments, blind spot hazards, and misjudgements by both drivers and surrounding road users. Accidents involving executing turns are a major safety concern. The primary challenges associated with turning manoeuvres for such vehicles include encroachment into adjacent lanes, extensive blind spots, unsafe turn speeds, inefficient signalling to other road users, etc, which may lead to accidents and can cause casualties.

Conventional turn assistance techniques, primarily focus on detecting vehicles in the blind spot when making a turn. However, these techniques do not account for the specific requirements of long vehicles that must perform a swinging out manoeuvre. Furthermore, in an example, conventional turn assistance techniques primarily address specific scenarios like log transportation in hilly terrains, rather than generalized solutions for all long vehicles requiring swing out turns.

Thus, there is a need for an improved solution that may solve the aforementioned problems of conventional turn assistance techniques.

### SUMMARY

Though driver assistance techniques are widely known, however, the existing solutions fail to tailor to the unique turning requirements of long vehicles. In addition, the existing solutions fail to enhance situational awareness, provide timely signalling, and optimize swing out manoeuvres.

Therefore, there is a need for an improved method and systems for assisting a vehicle in making a turn.

It is therefore an object of the present disclosure to provide a method and a system for assisting a vehicle in making a turn.

This and other objects are achieved by means of a system and a method defined in the appended claims. The term exemplary is in the present context to be understood as serving as instance, example, or illustration.

According to an aspect of the present disclosure, a method for assisting a vehicle in making a turn is provided. The method comprises receiving a destination route map comprising one or more routes for the vehicle. Further, the method comprises of receiving data associated with surroundings of the vehicle. In addition, the method comprises of determining a turn clearance status based on the data, one or more dimensions of the vehicle, and at least one selected route of the one or more routes, wherein the turn clearance status comprises at least one of: a positive status or a negative status. Furthermore, the method comprises of determining a first turn trajectory for a first unit of the vehicle and a second turn trajectory for a second unit of the vehicle. The method also comprises of initiating a turn for the first unit and the second unit in the first turn trajectory and the second turn trajectory, respectively, when the turn clearance status comprises the positive status.

Optionally, the method comprises of determining an updated first turn trajectory and an updated second turn trajectory when the clearance status comprises the negative status.

Optionally, the method comprises of determining a probability of interference of at least one ambient entity in the first turn trajectory and the second turn trajectory. Further, the method comprises of initiating one or more hazard mitigation actions based on the probability of interference.

Optionally, determining the probability of interference of the at least one ambient entity comprises of processing the data associated with the surroundings of the vehicle using one or more dynamic learning models to obtain one or more attributes of the at least one ambient entity.

Optionally, the one or more hazard mitigation actions comprise one or more of: applying brakes of the vehicle; activating lane assist for the vehicle; correction in turn radius of the vehicle; and triggering an alert for a driver of the vehicle.

Optionally, the data associated with the surroundings of the vehicle is captured by one or more of: one or more imaging devices, and/or long and short range radars.

Optionally, the data comprises one or more of: co-ordinates of the at least one ambient entity, dimensions of the at least one ambient entity, category of the ambient entity, vacant regions around the vehicle, one or more drivable paths around the vehicle, and one or more road furniture.

According to another aspect of the present disclosure, a system for assisting a vehicle in making a turn is provided. The system comprises processing circuitry configured to receive a destination route map comprising one or more routes for the vehicle. The processing circuitry is configured to receive data associated with the surroundings of the vehicle. Further, the processing circuitry is configured to determine a turn clearance status based on the data, one or more dimensions of the vehicle, and at least one selected route of the one or more routes, wherein the turn clearance status comprises at least one of: a positive status or a negative status. In addition, the processing circuitry is configured to determine a first turn trajectory for a first unit of the vehicle and a second turn trajectory for a second unit of the vehicle. Furthermore, the processing circuitry is configured to initiate a turn for the first unit and the second unit in the first turn trajectory and the second turn trajectory, respectively, when the turn clearance status comprises the positive status.

Optionally, the processing circuitry is configured to determine an updated first turn trajectory and an updated second turn trajectory when the clearance status comprises the negative status.

Optionally, the processing circuitry is configured to determine a probability of interference of at least one ambient entity in the first turn trajectory and the second turn trajectory. In addition, the processing circuitry is configured to initiate one or more hazard mitigation actions based on the probability of interference.

Optionally, the processing circuitry is configured to process the data associated with the surroundings of the vehicle using one or more dynamic learning models to obtain one or more attributes of the at least one ambient entity.

Optionally, the processing circuitry, when initiating the one or more hazard mitigation actions, is configured to facilitate one or more of: apply brakes of the vehicle, activate lane assist of the vehicle; and trigger an alert for a driver of the vehicle.

Optionally, the data associated with the surroundings of the vehicle is captured by one or more of: one or more imaging devices, and/or long and short range radars.

According to another aspect of the present disclosure, there is provided a computer program when loaded and run on a system, causes processing circuitry of the system to perform corresponding steps of method for assisting a vehicle in making a turn.

According to another aspect of the present disclosure, there is provided a computer readable medium having stored thereon a computer program.

Some embodiments disclosed herein have one or more of the following advantages:

The proposed system and method significantly reduce accidents by assisting an operator of the vehicle in executing safe turning manoeuvres, preventing collisions with curbs, vehicles, pedestrians, and other objects.

The proposed system and method integrate data associated with surroundings of the vehicle to calculate the optimal turning point, providing real-time assistance to the operator of the vehicle and signalling other traffic participants.

In addition, by analysing one or more road furniture comprising lane markings, curbs, and turn signboards, the system and the method determines the appropriate turn curvature, ensuring the vehicle follows an optimal path and avoids excessive lane encroachments.

The proposed system and method separately calculate the trajectory of one or more units of an articulated vehicle to ensure multiple sections of the articulated vehicle navigate safely without obstructing multiple lanes.

The proposed system and method utilize one or more dynamic learning model to predict the speed and trajectory of surrounding vehicles. Therefore, if a potential collision is detected, the system adjusts the vehicle’s speed or applies braking using an Emergency Brake Assist (EBA).

The proposed system and method perform path planning based on the destination route map, allowing vehicles to prepare for turns in advance, reducing last-minute adjustments and improving manoeuvrability.

Other advantages may be readily apparent to one having skill in the art. Certain embodiments may have none, some, or all of the recited advantages.

### BRIEF DESCRIPTION OF DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 illustrates a prior art example depicting challenges associated with turning of a vehicle;

FIG. 2 illustrates a block diagram of a system for assisting a vehicle in making a turn, according to some embodiments herein;

FIG. 3 illustrates a block diagram of processing circuitry of the system as illustrated in FIG. 2, according to some embodiments herein;

FIG. 4 illustrates a flowchart of a method 400 for assisting the vehicle in making the turn, according to some embodiments herein;

FIG. 5 illustrates an exemplary scenario for assisting the vehicle in making the turn, according to some embodiments herein;

FIG. 6 illustrates additional details of the method for assisting the vehicle in making the turn, according to some embodiments herein;

FIG. 7 illustrates an example computing environment implementing the system, as shown in FIG. 2, assisting the vehicle in making the turn, according to some embodiments herein.

### DETAILED DESCRIPTION

Aspects of the present disclosure will be described more fully hereinafter with reference to the accompanying drawings. The systems and methods disclosed herein can, however, be realized in many different forms and should not be construed as being limited to the aspects set forth herein. Like numbers in the drawings refer to like elements throughout.

The terminology used herein is for the purpose of describing particular aspects of the disclosure only and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms "a", "an" and "the" are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a system and a method, it may also be embodied in one or more processors and one or more memories coupled to the one or more processors, wherein the one or more memories store one or more programs that perform the steps, services and functions disclosed herein when executed by the one or more processors.

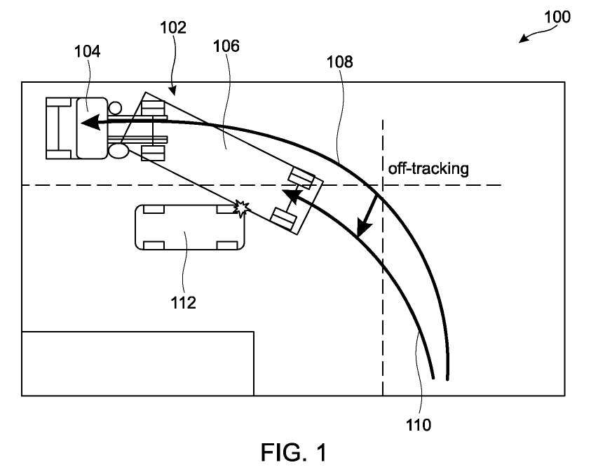

FIG. 1 illustrates a prior art scenario 100 depicting challenges associated with turning of a vehicle 102, particularly in a case of an articulated vehicle such as trucks and trailers. The vehicle 102 comprises a first unit 104 and a second unit 106. FIG. 1 demonstrates a phenomenon of off-tracking, which occurs when the second unit 106 of the vehicle 102 follows a different path than the first unit 104 of the vehicle 102 during a turn. As shown in FIG. 1, when the vehicle 102 makes the turn, a first path 108 of the first unit 104 of the vehicle 102 follows a wider arc compared to a second path 110 of the second unit 106 of the vehicle 102. Due to this off-tracking effect, the second unit 106 of the vehicle 102 swings inward, which may cause a collision with an ambient entity 112. In the illustrated prior art scenario 100, the second unit 106 of the vehicle 102 may deviate from the intended path and collide with the ambient entity 112.

The off-tracking phenomenon introduces several safety risks, including potential lane encroachments, blind spot hazards, and misjudgements by both drivers and surrounding road users. The issue arises due to the inherent design of articulated vehicles, where a pivot point between the first unit 104 and the second unit 106 of the vehicle 102 leads to a difference in trajectory.

Conventional systems often rely on driver experience or visual estimation to manage turns, which may not be sufficient to prevent off-tracking incidents while performing swing-out manoeuvres. Thus, there is a need for improved vehicle turn assistance systems that can minimize off-tracking and reduce the risk of collisions.

As mentioned there remains a need to provide an improved solution for assisting a vehicle in making a turn. Accordingly, the present disclosure provides a method and a system for assisting a vehicle in making a turn. The system of the present disclosure provides assistance for an operator of the vehicle in executing safe turning manoeuvres, preventing collisions with ambient entities.

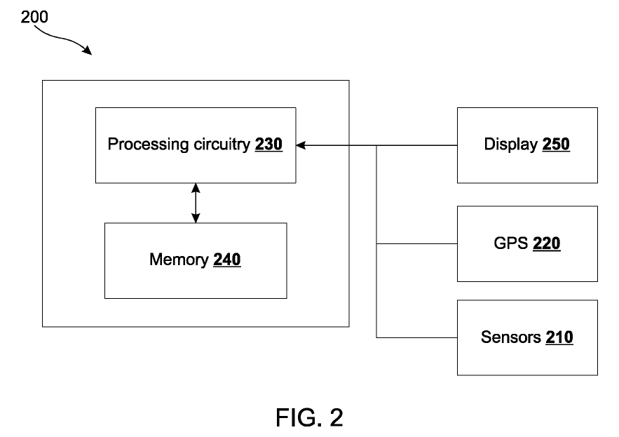

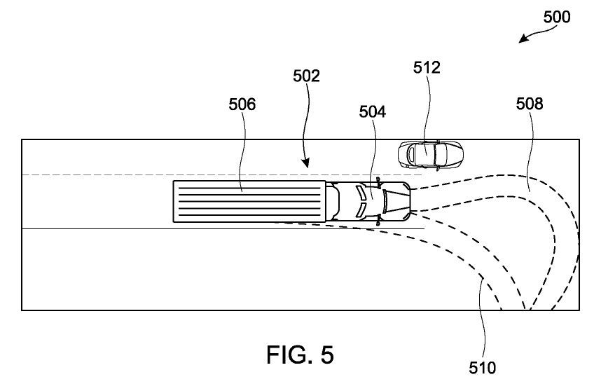

FIG. 2 illustrates a block diagram of a system 200 for assisting a vehicle (discussed later in FIG. 5) in making a turn, according to some embodiments herein. The system 200 may be mounted in the vehicle and may be configured to facilitate in assisting the vehicle in making the turn. The system 200 comprises one or more sensors 210, a global positioning system (GPS) 220, and processing circuitry 230. The processing circuitry 230 is configured to receive a destination route map comprising one or more routes for the vehicle. The processing circuitry 230 is further configured to receive data associated with surroundings of the vehicle. In addition, the processing circuitry 230 is configured to determine a turn clearance status based on the data, one or more dimensions of the vehicle, and at least one selected route of the one or more routes. Further, the turn clearance status comprises at least one of: a positive status or a negative status. The processing circuitry 230 is configured to determine a first turn trajectory (discussed later in FIG. 5) for a first unit (discussed later in FIG. 5) of the vehicle and a second turn trajectory (discussed later in FIG. 5) for a second unit (discussed later in FIG. 5) of the vehicle. Furthermore, the processing circuitry 230 is configured to initiate a turn for the first unit and the second unit in the first turn trajectory and the second turn trajectory, respectively, when the turn clearance status comprises the positive status. The term “positive status” as used in context of the present disclosure refers to a scenario when vehicle is able to initiate the turn due to absence of the at least one ambient entity in the first and second turn trajectories of the vehicle.

In an example, the one or more sensors 210 are arranged to provide data associated with surroundings of the vehicle.

In an example, the GPS 220 is arranged to provide destination route map comprising one or more routes for the vehicle. In another example, the destination route map may be obtained from an internal component that is operatively coupled, either directly or indirectly, to the processing circuitry 230. Further, in another example, the processing circuitry 230 is configured to receive the destination route from an external source. In such an example, the external source may comprise one or more of: a server or a cloud-based system or another suitable external data source or auxiliary system.

In another example, the first turn trajectory of the first unit and the second turn trajectory of the second unit may be displayed on a display 250.

In an example, the first turn trajectory for the first unit of the vehicle and the second turn trajectory for the second unit of the vehicle is based on dimensions of the vehicle and the data associated with surroundings of the vehicle.

In an example, the processing circuitry 230 may be coupled to a memory 240 for storing data associated with surroundings of the vehicle. In addition, the processing circuitry 230 may be communicatively coupled to the one or more sensors 210, the GPS 220, and the display 250.

In some embodiments, the processing circuitry 230 is configured to determine an updated first turn trajectory and an updated second turn trajectory when the clearance status comprises the negative status. The term “negative status” as used in context of the present disclosure refers to a scenario when vehicle is not able to initiate the turn due to presence of the at least one ambient entity in the first and second turn trajectories of the vehicle.

In some embodiments, the processing circuitry 230 is configured to determine a probability of interference of at least one ambient entity in the first turn trajectory and the second turn trajectory. The term “probability of interference” as used in context of the present disclosure refers to risk of intrusion of the at least one ambient entity in the first and second turn trajectories, while the vehicle has initiated the turn. In addition, the processing circuitry 230 is configured to initiate one or more hazard mitigation actions based on the probability of interference. In an example, the at least one ambient entity may comprise one or more of: a pedestrian, cyclists, animals, roadside objects, environmental obstacles, and curbs. Embodiments of the present disclosure are intended to include and/or otherwise cover any type of the at least one ambient entity, without deviating from the scope of the present disclosure.

In some embodiments, the processing circuitry 230 is configured to process the data associated with the surroundings of the vehicle using one or more dynamic learning models to obtain one or more attributes of the at least one ambient entity (discussed later in FIG. 5). In an example, the one or more dynamic learning models may comprise one or more of: Deep Q-Networks (DQN) and/or Proximal Policy Optimization (PPO).

In some embodiments, the processing circuitry 230, when initiating the one or more hazard mitigation actions, is configured to facilitate one or more of: apply brakes of the vehicle, activate lane assist of the vehicle, correction in turn radius of the vehicle, and trigger an alert for a driver of the vehicle.

In some embodiments, the data associated with surroundings of the vehicle is captured by one or more of: one or more imaging devices, and/or long and short range radars.

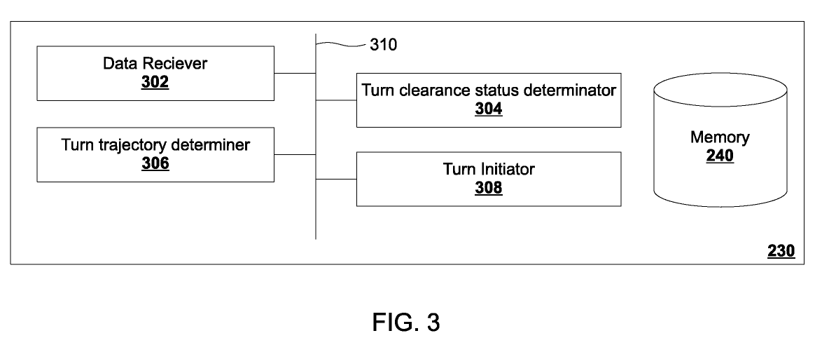

FIG. 3 illustrates a block diagram of the processing circuitry 230 of the system 200 as illustrated in FIG. 2, according to some embodiments of the present disclosure. The processing circuitry 230 may comprise one or more units that may be configured to execute one or more functionalities associated with the system 200. Each unit of the one or more units of the processing circuitry 230 may be a set of instructions that, when executed by hardware circuitry of the processing circuitry 230, may be configured to perform a specific functionality of the system 200.

The processing circuitry 230 may comprise a data receiver unit 302, a turn clearance status determination unit 304, a turn trajectory determination unit 306, and a turn initiation unit 308. The data receiver unit 302, the turn clearance status determination unit 304, the turn trajectory determination unit 306, and the turn initiation unit 308 may be communicatively coupled to each other. Specifically, the data receiver unit 302, the turn clearance status determination unit 304, the turn trajectory determination unit 306, and the turn initiation unit 308 may be communicatively coupled to each other by way of a communication channel 310. The communication channel 310 may be one of, a wired communication channel and a wireless communication channel. Embodiments of the present disclosure are intended to include and/or otherwise cover any type of the communication channel 310, without deviating from the scope of the present disclosure.

The data receiver unit 302 may be configured to facilitate the processing circuitry 230 to receive the destination route map comprising one or more routes for the vehicle and the data associated with surroundings of the vehicle.

The turn clearance status determination unit 304 may be configured to facilitate the processing circuitry 230 to determine the turn clearance status based on the data, one or more dimensions of the vehicle, and at least one selected route of the one or more routes.

Further, the turn trajectory determination unit 306 may be configured to facilitate the processing circuitry 230 to determine the first turn trajectory (discussed later in FIG. 5) for the first unit (discussed later in FIG. 5) of the vehicle and the second turn trajectory (discussed later in FIG. 5) for the second unit (discussed later in FIG. 5) of the vehicle.

The turn initiation unit 308 may be configured to facilitate the processing circuitry 230 to initiate the turn for the first unit and the second unit in the first turn trajectory and the second turn trajectory, respectively, when the turn clearance status comprises the positive status.

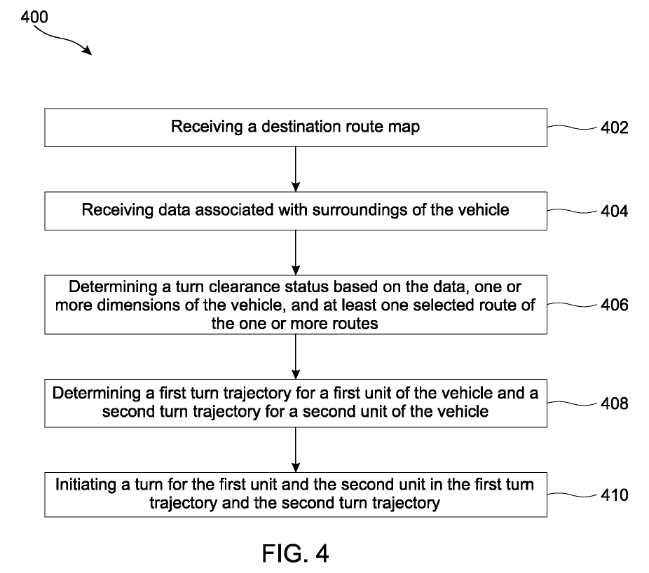

FIG. 4 illustrates a flowchart of a method 400 for assisting a vehicle (discussed later in FIG. 5) in making a turn, according to some embodiments herein. The method 400 may facilitate assisting the vehicle in making the turn by way of the system 200 of FIG. 2.

At step 402, the method 400 provides a step of receiving a destination route map comprising one or more routes for the vehicle.

At step 404, the method 400 provides a step of receiving data associated with surroundings of the vehicle.

At step 406, the method 400 provides a step of determining a turn clearance status based on the data, one or more dimensions of the vehicle, and at least one selected route of the one or more routes. The turn clearance status comprises at least one of: a positive status or a negative status.

At step 408, the method 400 provides a step of determining a first turn trajectory for a first unit of the vehicle and a second turn trajectory for a second unit of the vehicle.

At step 410, the method 400 provides a step of initiating a turn for the first unit and the second unit in the first turn trajectory and the second turn trajectory, respectively, when the turn clearance status comprises the positive status.

Details of the method 400 are similar to the details of the system 200 as discussed above and hence are not repeated for the sake of brevity.

In some embodiments, the method 400 provides a step of determining an updated first turn trajectory and an updated second turn trajectory when the clearance status comprises the negative status.

In some embodiments, the method 400 provides a step of determining a probability of interference of at least one ambient entity in the first turn trajectory and the second turn trajectory. In addition, the method 400 provides a step of initiating one or more hazard mitigation actions based on the probability of interference.

In some embodiments, determining the probability of interference of the at least one ambient entity in the method 400 comprises a step of processing the data associated with the surroundings of the vehicle using one or more dynamic learning models to obtain one or more attributes of the at least one ambient entity.

In some embodiments, the one or more hazard mitigation actions comprise one or more of: applying brakes of the vehicle; activating lane assist for the vehicle; correction of turn radius of the vehicle; and triggering an alert for a driver of the vehicle.

In some embodiments, the data associated with surroundings of the vehicle is captured by one or more of: one or more imaging devices, and/or long and short range radars.

In some embodiments, the data associated with surroundings of the vehicle comprises one or more of: co-ordinates of the at least one ambient entity, dimensions of the at least one ambient entity, category of the ambient entity, vacant regions around the vehicle, one or more drivable paths around the vehicle, and one or more road furniture.

In an example, the one or more road furniture comprises one or more of: traffic signs; traffic lights; barriers and guardrails; road markings; bollards and curbs; streetlights; speed bumps and rumble strips; bus stops & shelters; and/or pedestrian crossings and overpasses.

FIG. 5 illustrates an exemplary scenario 500 for assisting a vehicle 502 in making a turn in accordance with the system 200 and method 400 according to some embodiments herein. In an example, the vehicle 502 is an articulated vehicle comprising a first unit 504 and a second unit 506. In another example, the vehicle 502 may be at least one of: long vehicle or short vehicle. In an example, the vehicle 502 may be a non-articulated vehicle comprising a single unit.

In the exemplary scenario 500, the processing circuitry 230 (as shown in FIG. 2) of the system 200 is configured to receive the destination route map comprising one or more routes for the vehicle 502 and the data associated with surroundings of the vehicle 502. The processing circuitry 230 is configured to determine the turn clearance status based on the data, one or more dimensions of the vehicle 502, and at least one selected route of the one or more routes. Further, the processing circuitry 230 is configured to determine a first turn trajectory 508 for the first unit 504 of the vehicle 502 and the second turn trajectory 510 for the second unit 506 of the vehicle 502. The processing circuitry 230 is further configured to initiate the turn for the first unit 504 and the second unit 506 in the first turn trajectory 508 and the second turn trajectory 510, respectively, when the turn clearance status comprises the positive status. Further, the processing circuitry 230 is further configured to determine the probability of interference of at least one ambient entity 512 in the first turn trajectory 508 and the second turn trajectory 510. In the exemplary scenario 500, the probability of interference of at least one ambient entity 512 is low when the vehicle 502 includes at least 1.5 times its turning radius gap with the ambient entity 512 and therefore, one or more hazard mitigation actions are not initiated.

In the exemplary scenario 500, swing-out operation is a key component in making the turn. Before initiating the turn, the first unit 504 moves outward into an adjacent lane to create sufficient space for the second unit 506 to clear a curb and complete the turn without cutting too sharply. The first turn trajectory 508 represents a path followed by the first unit 504 of the vehicle 502, which takes a wider arc to compensate for movement of the second unit 506. Conversely, the second turn trajectory 510 follows a tighter curve due to pivoting action of the second unit 506 at a hitch point (not shown). This difference in trajectory requires precise calculations by the system 200, ensuring that the turn is executed efficiently while minimizing risks such as lane encroachment, blind spot hazards, and unintended collisions.

In another exemplary scenario, when the vehicle 502 does not have at least 1.5 times its turning radius gap with the ambient entity 512, the probability of interference of at least one ambient entity 512 is high. In view thereof, the processing circuitry 230 is configured to initiate one or more hazard mitigation actions based on the probability of interference. Further, the one or more hazard mitigation actions comprise one or more of: applying brakes of the vehicle 502, activating lane assist for the vehicle 502, triggering an alert for a driver of the vehicle 502, and correcting in the turn radius of the vehicle 502.

Therefore, the system 200 and the method 400 significantly reduce accidents by assisting an operator of the vehicle 502 in executing safe turning manoeuvres, preventing collisions with curbs, vehicles, pedestrians, and other objects. Further, the system 200 and method 400 integrate data associated with surroundings of the vehicle 502 to calculate an optimal turning point, providing real-time assistance to the operator of the vehicle 502 and signalling other traffic participants (ambient entities). In addition, by analysing one or more road furniture comprising lane markings, curbs, and turn signboards, the system 200 and the method 400 determines an appropriate turn curvature, ensuring the vehicle 502 follows an optimal path and avoids excessive lane encroachments. Furthermore, the system 200 and the method 400 separately calculates the turn trajectories of the first unit 504 and the second unit 506 of the vehicle 502 to ensure multiple sections of the vehicle 502 navigate safely without obstructing multiple lanes. The system 200 and the method 400 utilize one or more dynamic learning models to predict a speed and trajectory of surrounding vehicles. Therefore, if a potential collision is detected, the system 200 adjusts the vehicle’s speed or applies braking using an Emergency Brake Assist (EBA). The system 200 and the method 400 performs path planning based on the destination route map, allowing vehicle 502 to prepare for turns in advance, reducing last-minute adjustments and improving manoeuvrability.

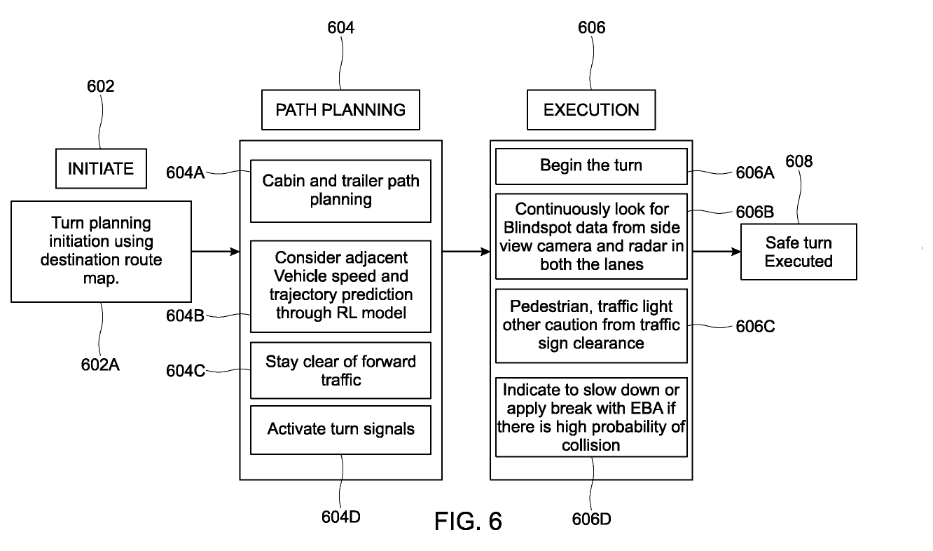

FIG. 6 illustrates additional details 600 of the method 400 for assisting the vehicle 502 in making the turn (shown in FIG. 5), according to some embodiments herein. The additional details 600 of the method 400 are divided into four distinct phases: an initiation phase 602, a path planning phase 604, an execution phase 606, and a completion phase 608. Each phase plays a critical role in ensuring the vehicle 502 to navigate the turn effectively while minimizing collision risks and optimizing safety for ambient entity. The assistance for the vehicle 502 in making the turn is performed in the following steps:

The initiation phase 602 serves as the starting point for the method 400. At step 602A, the destination route map is utilized to plan a turning manoeuvre of the vehicle 502. The initiation phase 602 sets a foundation for determining the appropriate first and second turn trajectory 508, 510 required for the turn. Further, in the initiation phase 602, upcoming turns are anticipated well in advance using preloaded navigation data, thereby allowing for smooth execution.

Once the turn is identified, the path planning phase 604 is initiated. At step 604A, an optimal path for the first unit 504 and the second unit 506 of the vehicle 502 is planned separately. At step 604B, speed and trajectory of the ambient entity 512 is calculated using reinforcement learning (RL) models for predicting any potential collisions. In an example, the ambient entity 512 comprises an adjacent vehicle. At step 604C, the vehicle 502 stays clear of any forward traffic to ensure no immediate obstacles block the first and second turn trajectory 508, 510. At step 604D, turn signals are activated to notify ambient entity 512 about turning intent of the vehicle 502, improving situational awareness.

During the execution phase 606, at step 606A, the turning manoeuvre begins. At step 606B, blind spots are continuously monitored by one or more sensors (not shown) to ensure no ambient entity 512 is in the turning path of the vehicle 502. In an example, the one or more sensors comprises at least one of: a side view imaging device or a radar. At step 606C, road furniture recognition is performed to detect important road signs (e.g., pedestrian crossings, no-turn zones, or traffic light signals) that could impact turn execution. Further, at step 606D, if a high probability of collision is detected, the driver of the vehicle 502 is indicated and the vehicle 502 automatically slows down or apply brakes using Emergency Braking Assist (EBA). In addition, of probability of collision is low the vehicle 502 continues the turning manoeuvre.

In the completion phase 608, the vehicle 502 successfully executes the turn and returns to a designated lane without any safety compromises.

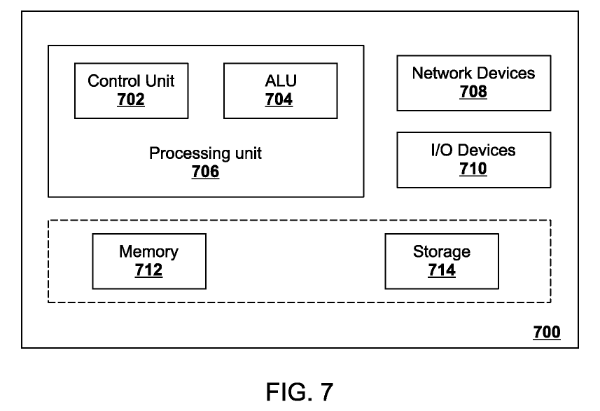

FIG. 7 illustrates an example computing environment implementing the system 200, as shown in FIG. 2, assisting the vehicle 502 in making the turn, according to some embodiments herein. As depicted in FIG. 7, the computing environment 700 comprises at least one data processing unit 706 that is equipped with a control unit 702 and an Arithmetic Logic Unit (ALU) 704, a plurality of networking devices 708 and a plurality Input output, I/O devices 710, a memory 712, a storage 714. The data processing unit 706 may be responsible for implementing the system 200 and the method 400 described in FIGS. 2-6. For example, the data processing unit 706 in some embodiments be equivalent to the processing circuitry 230 of the system 200 as described above in reference to FIG. 2. The data processing unit 706 is capable of executing software instructions stored in memory 712. The data processing unit 706 receives commands from the control unit 702 in order to perform its processing. Further, any logical and arithmetic operations involved in the execution of the instructions are computed with the help of the ALU 704.

The computer program is loadable into the data processing unit 706, which may, for example, be comprised in an electronic apparatus (such as the platform). When loaded into the data processing unit 706, the computer program may be stored in the memory 712 associated with or comprised in the data processing unit 706. According to some embodiments, the computer program may, when loaded into and run by the data processing unit 706, cause execution of method steps according to, for example, any of the methods illustrated in FIG. 4 as described herein.

The overall computing environment 700 may be composed of multiple homogeneous and/or heterogeneous cores, multiple CPUs of different kinds, special media, and other accelerators. Further, the plurality of data processing unit 706 may be located on a single chip or over multiple chips.

The algorithm comprising of instructions and codes required for the implementation are stored in either the memory 712 or the storage 714 or both. At the time of execution, the instructions may be fetched from the corresponding memory 712 and/or storage 714 and executed by the data processing unit 706.

In case of any hardware implementations various networking devices 708 or external I/O devices 710 may be connected to the computing environment to support the implementation through the networking devices 708 and the I/O devices 710.

### THE REFERENCE SIGNS ARE

Prior art scenario 10
Vehicle 102, 502
First Unit 104, 504
Second unit 106, 506
First path 108
Second path 110
Ambient entity 112, 512
System 200
One or more sensors 210
Global positioning system (GPS) 220
Processing circuitry 230
Memory 240
Display 250
Data receiver unit 302
Turn clearance status determination unit 304
Turn trajectory determination unit 306
Turn initiation unit 308
Communication channel 310
Method 400
Exemplary scenario of the present subject matter 500
First turn trajectory 508
Second turn trajectory 510
Additional details 600 of the method 400
Initiation phase 602
Path planning phase 604
Execution phase 606
Completion phase 608
Computing environment 700
Control unit 702
Arithmetic Logic Unit (ALU) 704
Processing unit 706
Network devices 708
I/O devices 710
Memory 712
Storage 714

The embodiments disclosed herein can be implemented through at least one software program running on at least one hardware device and performing network management functions to control the elements. The elements shown in FIG. 7 include blocks which can be at least one of a hardware device, or a combination of hardware device and software module.

1. A method for assisting a vehicle in making a turn, the method comprising:
receiving a destination route map comprising one or more routes for the vehicle;
receiving data associated with surroundings of the vehicle;
determining a turn clearance status based on the data, one or more dimensions of the vehicle, and at least one selected route of the one or more routes, wherein the turn clearance status comprises at least one of: a positive status or a negative status;
determining a first turn trajectory for a first unit of the vehicle and a second turn trajectory for a second unit of the vehicle;
initiating a turn for the first unit and the second unit in the first turn trajectory and the second turn trajectory, respectively, when the turn clearance status comprises the positive status.

2. The method as claimed in claim 1, wherein the method comprises:
determining an updated first turn trajectory and an updated second turn trajectory when the clearance status comprises the negative status.

3. The method of claim 1, wherein the method comprises:
determining a probability of interference of at least one ambient entity in the first turn trajectory and the second turn trajectory; and
initiating one or more hazard mitigation actions based on the probability of interference.

4. The method of claim 3, wherein determining the probability of interference of the at least one ambient entity comprises:
processing the data associated with the surroundings of the vehicle using one or more dynamic learning models to obtain one or more attributes of the at least one ambient entity.

5. The method of claim 3, wherein the one or more hazard mitigation actions comprise one or more of:
applying brakes of the vehicle;
activating lane assist for the vehicle;
correction in turn radius of the vehicle; and
triggering an alert for a driver of the vehicle.

6. The method of claim 1, wherein the data associated with surroundings of the vehicle is captured by one or more of: one or more imaging devices, and/or long and short range radars.

7. The method of claim 3, wherein the data associated with surroundings of the vehicle comprises one or more of: co-ordinates of the at least one ambient entity, dimensions of the at least one ambient entity, category of the ambient entity, vacant regions around the vehicle, one or more drivable paths around the vehicle, and one or more road furniture.

8. A system for assisting a vehicle in making a turn, the system comprising:
processing circuitry configured to:
receive a destination route map comprising one or more routes for the vehicle;
receive data associated with surroundings of the vehicle;
determine a turn clearance status based on the data, one or more dimensions of the vehicle, and at least one selected route of the one or more routes, wherein the turn clearance status comprises at least one of: a positive status or a negative status;
determine a first turn trajectory for a first unit of the vehicle and a second turn trajectory for a second unit of the vehicle;
initiate a turn for the first unit and the second unit in the first turn trajectory and the second turn trajectory, respectively, when the turn clearance status comprises the positive status.

9. The system as claimed in claim 8, wherein the processing circuitry is configured to:
determine an updated first turn trajectory and an updated second turn trajectory when the clearance status comprises the negative status.

10. The system as claimed in claim 9, wherein the processing circuitry is configured to:
determine a probability of interference of at least one ambient entity in the first turn trajectory and the second turn trajectory; and
initiate one or more hazard mitigation actions based on the probability of interference.

11. The system as claimed in claim 9, wherein the processing circuitry is configured to:
process the data associated with the surroundings of the vehicle using one or more dynamic learning models to obtain one or more attributes of at least one ambient entity.

12. The system of claim 10, wherein the processing circuitry, when initiating the one or more hazard mitigation actions, is configured to facilitate one or more of:
apply brakes of the vehicle;
activate lane assist of the vehicle;
correction in turn radius of the vehicle; and
trigger an alert for a driver of the vehicle.

13. The system according to claim 8, wherein the data associated with surroundings of the vehicle is captured by one or more of: one or more imaging devices, and/or long and short range radars.

14. A computer program comprising instructions, which, when executed by a computer, cause the computer to carry out the method of claim 1.

15. A computer readable medium having stored thereon the computer program of claim 14.
